(19) United States
(12) Patent Application Publication
(10) Pub. No.: US 2012/0097723 A1
(43) Pub. Date: Apr. 26, 2012

(54) NAVIGATION SYSTEM FOR USE IN A VEHICLE

(76) Inventor: Amaiak Khatchatrian, Udenhout (NL)

(21) Appl. No.: 13/262,042

(22) PCT Filed: Mar. 31, 2010
(86) PCT No.: PCT/NL2010/050163

§ 371 Date: Dec. 22, 2011

(30) Foreign Application Priority Data
Mar. 31, 2009 (NL) 2002690

(51) Int. Cl. B60R 7/06

(52) U.S. Cl. 224/483

(57) ABSTRACT

A navigation system 1 comprises a navigation apparatus 5 and coupling means for securing the navigation apparatus to the dashboard 3 of a vehicle. The coupling means are formed by an elongated flexible element 11 and a mounting plate 9 connected thereto to which the navigation apparatus is mounted and securing means connected to the element 11. These securing means are arranged as clamping means 7.

By arranging the securing means of the navigation system as clamping means 7, the navigation system can be fixed to, for example, a projecting edge of the dashboard 3 of a motor car. The clamping force can then be so great that the navigation system 1 does not loosen from the dashboard in the event of vibration. In addition, the navigation system can be clamped to the dashboard at the location where it does not obstruct the driver's visibility.

### FIELD OF THE INVENTION

The invention relates to a navigation system for use in a vehicle, comprising a navigation apparatus as well as coupling means for coupling the navigation apparatus to the vehicle, which coupling means comprise holding means to which the navigation apparatus is connected, as well as securing means for securing the holding means to the vehicle.

### STATE OF ART

A navigation system of this type is generally known. In the known navigation system the securing means are formed by a suction pad with which the holder is to be fastened to the windscreen of a motor car. A disadvantage of this known navigation system is that the suction pad detaches from the windscreen and drops in the course of time or owing to heavy vibrations A further disadvantage is that the known navigation system takes away part of the view when affixed to the windscreen of the motor car.

### SUMMARY OF THE INVENTION

It is an object of the invention to provide a navigation system of the type defined in the opening paragraph, which is sturdier and can be secured in a different manner than against the windscreen. For this purpose the navigation system according to the invention is characterized in that securing means are arranged as clamping means having two clamping surfaces spaced from each other and facing each other for clamping the holding element to a part of the dashboard of the vehicle. By arranging the securing means as clamping means, the navigation system can be clamped to for example a projecting edge of the dashboard of a motor car. The clamping force may then be such that the navigation system will not loosen from the dashboard in the event of vibration. In addition, the navigation system can be clamped to the dashboard at the place where it does not obstruct the driver's visibility.

The clamping means may comprise a C-shaped resilient element which is clamped to a projecting edge of the dashboard. A preferred embodiment of the navigation system according to the invention is characterized, however, in that the clamping means additionally comprise displacement means for moving the clamping surfaces towards each other or away from each other.

Furthermore, the clamping means preferably comprise at least one clamping element on which one of the clamping surfaces is located and which is pivotable near the middle around a pivot pin. As a result, the clamping surfaces can be brought into contact with the dashboard over their entire surface due to which the navigation system can be clamped better to the dashboard and causes less chance of the dashboard being damaged.

For bringing the navigation system to the right position and at the right location on the dashboard after the clamping means have been secured to the dashboard, the holding means preferably comprise a holding element as well as an elongated flexible element connected thereto with a first extremity, the second extremity of which flexible element being detachably connected to the clamping element. As a consequence of the latter characteristic feature the flexible element can be removed in a simple manner if the navigation system is not used.

A further embodiment of the navigation system according to the invention is characterised in that the clamping means comprise two arms hingeably connected to each other by a first extremity, the clamping element being pivotably connected to the other, second extremity of one of the arms. As a result, the clamping surfaces can even be better fixed to an edge of the dashboard.

The displacement means preferably comprise an auxiliary element which projects with a first extremity through a hole in one of the arms and with the other, its second extremity is connected to the other arm, as well as a lever of which one extremity is eccentrically and pivotably connected to the first extremity of the auxiliary element. In consequence, a simple movement will suffice to generate a large clamping force.

Still a further embodiment of the navigation system according to the invention is characterized in that the holding element comprises a carrier which is connected to the first extremity of the flexible element, which carrier comprises a mounting plate which has holes and slots for mounting a navigation apparatus or a holder for a navigation apparatus. As a result, almost any navigation apparatus and any existing holder can be fixed to the holding element with bolts or screws in a simple manner.

### BRIEF DESCRIPTION OF THE DRAWINGS

The invention will now be described in more detail based on examples of embodiment of the navigation system while reference is made to the appended drawing figures, in which:

FIG. 1 gives a diagrammatic representation a first embodiment of the navigation system fixed to a dashboard;

FIG. 2 shows the securing means of the navigation system represented in a diagrammatic manner in FIG. 1; and

FIG. 3 shows a second embodiment of the navigation system according to the invention.

### DETAILED DESCRIPTION OF THE DRAWINGS

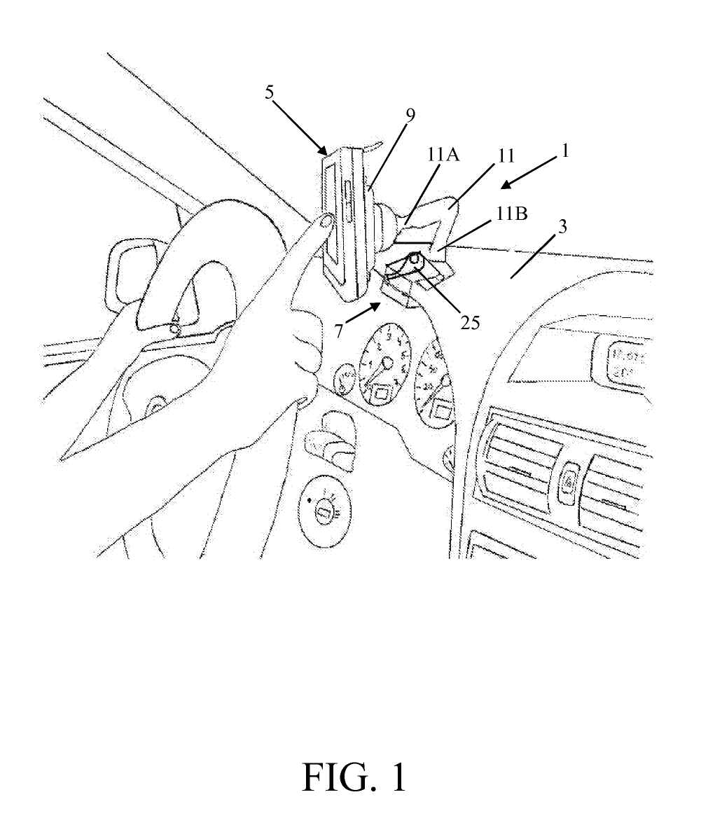

FIG. 1 gives a diagrammatic representation of a first embodiment of the navigation system according to the invention fixed to a dashboard 3 of a motor car. The navigation system 1 comprises a navigation apparatus 5 and coupling means for fixing the navigation apparatus to the dashboard 3. The coupling means are formed by holding means and clamping means 7. These holding means are formed by a mounting plate 9 and a connected, elongated flexible element 11 formed like a snake which can be bent to any desired position and stays in that position when let loose. The mounting plate is connected to a first extremity 11A of the flexible element, and the other, second extremity 11B of the flexible element is connected to the clamping means 7.

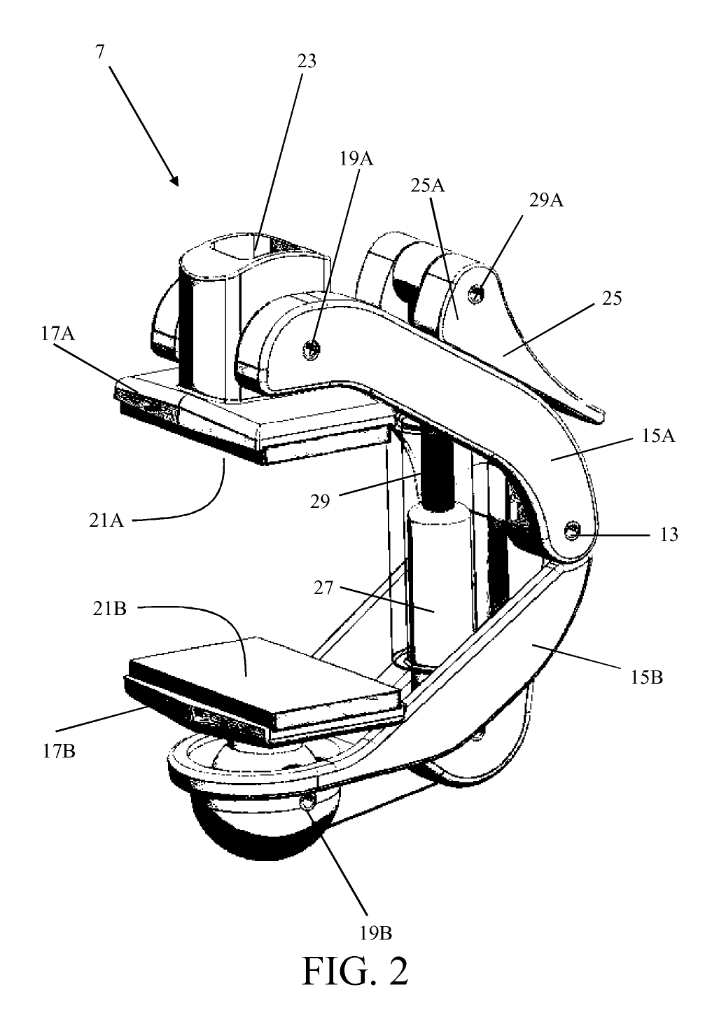

FIG. 2 gives a detailed representation of the clamping means 7 of the navigation system 1. The clamping means have two arms 15A and 15B connected to each other by means of a first extremity hingeable around a pivot pin 13. The other, second extermities of the arms are provided with clamping elements 17A and 17B. These clamping elements are formed by clamping plates which are hingeingly connected to the arms by means of hingeing shafts 19A and 19B near the middle. The clamping plates are provided with clamping surfaces 21A and 21B which are facing each other.

The flexible element 11 can be coupled to the clamping element 17B by means of the second extremity 11B. For this purpose the clamping element has a recess 23.

The clamping means further comprise displacement means for moving the clamping elements towards each other or away from each other. These displacement elements are formed by an auxiliary element and a pivotable lever 25 connected thereto. The auxiliary element is formed by a cylinder 27 accommodating a piston 29 moveable therein and a pressure spring pushing the piston outwards. An extremity of the piston 29 projects through an opening in the arm and the cylinder is connected to the arm. The lever 25 is positioned at the end of the piston 29, an extremity 25A of the lever 25 being pivotably connected to the piston. This extremity of the lever is eccentrically arranged on a pivot pin 29A.

The mounting plate 9 has holes and slots for mounting the navigation apparatus or a holder for the navigation apparatus.

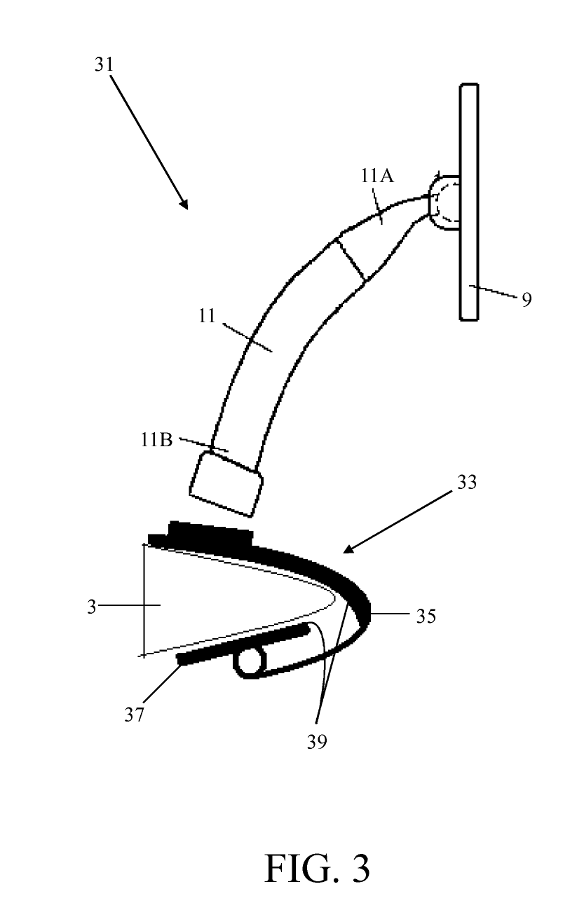

In the second embodiment of the navigation system 31 according to the invention shown in FIG. 3 the clamping means 33 are formed by a U-shaped bracket 35 whose legs can resiliently be bent away from each other. A clamping element 37 is hingeably connected to the extremity of one of the legs. The sides of the clamping element 37 and of the bracket 35 facing each other form the clamping surfaces 39 and are provided with double-sided tape.

Albeit the invention has been described in the foregoing with reference to the drawings, it should be observed that the invention is not by any manner or means restricted to the embodiment shown in the drawings. The invention also extends to all embodiments deviating from the embodiments shown in the drawings within the spirit and scope defined by the claims.

1. A navigation system for use in a vehicle, comprising a navigation apparatus as well as coupling means for coupling the navigation apparatus to the vehicle, which coupling means comprise holding means to which the navigation apparatus is connected, as well as securing means for securing the holding means to the vehicle, characterised in that securing means are arranged as clamping means having two clamping surfaces spaced from each other and facing each other for clamping the holding element to a part of the dashboard of the vehicle.

2. A navigation system as claimed in claim 1, characterised in that the clamping means additionally comprise displacement means for moving the clamping surfaces towards each other or away from each other.

3. A navigation system as claimed in claim 1 or 2, characterised in that the clamping means preferably comprise at least one clamping element on which one of the clamping surfaces is located and which is pivotable near the middle around a pivot pin.

4. A navigation system as claimed in claim 3, characterised in that the holding means preferably comprise a holding element as well as an elongated flexible element connected thereto with a first extremity, the second extremity of which flexible element being detachably connected to the clamping element.

5. A navigation system as claimed in claim 4, characterised in that the clamping means comprise two arms hingeably connected to each other by a first extremity, the clamping element being pivotably connected to the other, second extremity of one of the arms.

6. A navigation system as claimed in claim 2, 3, 4 or 5, characterised in that the displacement means comprise an auxiliary element which projects with a first extremity through a hole in one of the arms and with the other, its second extremity is connected to the other arm, the clamping means being present at the first extremity.

7. A navigation system as claimed in claim 4, 5 or 6, characterised in that the holding element comprises a carrier which is connected to the first extremity of the flexible element, which carrier comprises a mounting plate which has holes and slots for mounting a navigation apparatus or a holder for a navigation apparatus.
